(19) United States
(12) Patent Application Publication
(10) Pub. No.: US 2026/0046737 A1
(43) Pub. Date: Feb. 12, 2026

(54) METHOD AND DEVICE FOR HANDOVER OPTIMIZATION

(71) Applicant: Samsung Electronics Co., Ltd., Gyeonggi-do (KR)

(72) Inventors: Yu PAN, Beijing (CN); Weiwei WANG, Beijing (CN); Hong WANG, Beijing (CN); Lixiang XU, Beijing (CN); Fuyuan LI, Beijing (CN)

(21) Appl. No.: 18/998,866

(22) PCT Filed: Aug. 2, 2023
(86) PCT No.: PCT/KR2023/011346

§ 371 Date: Jan. 27, 2025

(30) Foreign Application Priority Data
Aug. 3, 2022 (CN) 202210928134.4

(51) Int. Cl. H04W 36/36; H04W 36/00

(52) U.S. Cl. CPC H04W 36/362; H04W 36/0069

(57) ABSTRACT

The disclosure relates to a 5G or 6G communication system for supporting a higher data transmission rate. The disclosure provides a method and device for handover optimization. The method includes transmitting a first message to a second node, wherein the first message includes at least one of first candidate secondary cell group (SCG) primary cell (PSCell) list information, measurement report configuration information, and first master cell group (MCG) plus SCG configuration information. When Conditional Handover (CHO)+Conditional PSCell Addition or Change (CPAC) is combined, a success rate of CHO+CPAC handover is improved by optimization of candidate PSCell selection or optimization of CHO+CPAC execution conditions, thus ensuring a user equipment (UE) to select a suitable target cell, improving robustness and reliability of a UE handover, and further improving system throughput.

### TECHNICAL FIELD

The disclosure relates to a wireless communication technology, and specifically, to a method and device for handover optimization.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4th generation (4G) communication system, efforts have been made to develop an improved 5th generation (5G) or pre-5G communication system. Therefore, the 5G or pre-5G communication system is also called “beyond 4G network”or “post LTE (long term evolution) system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Solution to Problem

According to various embodiments of the disclosure, a method of handover optimization performed by a first node is provided, including: transmitting a first message to a second node, wherein the first message includes at least one of first candidate secondary cell group (SCG) primary cell (PSCell) list information, measurement report configuration information, and first master cell group (MCG) plus SCG configuration information.

According to an implementation of the disclosure, the first candidate PSCell list information includes at least one of the following information: a candidate PSCell identity item, Synchronization Signal Block (SSB) frequency information, a Cell Global Identifier (CGI), a Physical Cell Identity (PCI), and a conditional reconfiguration identification.

According to an implementation of the disclosure, the measurement report configuration information includes a measurement report type indicating whether a measurement report is a periodical report or an event-triggered report.

According to an implementation of the disclosure, the method further includes: receiving a second message from the second node, wherein the second message including a measurement report; transmitting second candidate PSCell list information and/or second MCG plus SCG configuration information to the second node based on the measurement report.

According to an implementation of the disclosure, the first MCG plus SCG configuration information is included in a message container and transmitted to the second node in a form of a handover command message or a handover command list message.

According to an implementation of the disclosure, the handover command message includes at least one of the following information: a conditional reconfiguration remove list, a conditional reconfiguration addition or modification list including at least one of a conditional reconfiguration identification, a conditional reconfiguration execution condition, a configuration identification and conditional reconfiguration information, and temporary MCG configuration information.

According to an implementation of the disclosure, the handover command list message includes at least one of the following information: a handover command addition or modification list including handover command information, a handover command release list including a handover command information identification, and temporary MCG configuration information.

According to an implementation of the disclosure, the method further includes: receiving a third message from the second node; and transmitting a Conditional PSCell Addition or Change (CPAC) execution condition configured for a PSCell to the second node based on the third message, wherein the third message includes at least one of the following information: identification information of a user equipment (UE), a candidate target cell identity, and conditional reconfiguration execution condition information of a candidate target cell.

According to an implementation of the disclosure, the method further includes: receiving a fourth message from a user equipment (UE), wherein the fourth message includes a configuration identification and/or a conditional reconfiguration identification, or the fourth message includes a Cell Radio Network Temporary Identifier (C-RNTI) Media Access Control (MAC) Control Element (CE).

According to various embodiments of the disclosure, a method of handover optimization performed by a second node is provided, including: receiving a first message from a first node, wherein the first message includes at least one of first candidate secondary cell group (SCG) primary cell (PSCell) list information, measurement report configuration information, and first master cell group (MCG) plus SCG configuration information.

According to an implementation of the disclosure, the first candidate PSCell list information includes at least one of the following information: a candidate PSCell identity item, Synchronization Signal Block (SSB) frequency information, a Cell Global Identifier (CGI), a Physical Cell Identity (PCI), and a conditional reconfiguration identification, and wherein the measurement report configuration information includes a measurement report type indicating whether a measurement report is a periodical report or an event-triggered report.

According to an implementation of the disclosure, the method further includes: transmitting a second message to the first node, wherein the second message comprises a measurement report; and receiving second candidate PSCell list information and/or second MCG plus SCG configuration information from the first node if the first candidate PSCell list information is updated.

According to an implementation of the disclosure, the first MCG plus SCG configuration information is included in a message container in a form of a handover command message or a handover command list message.

According to an implementation of the disclosure, the handover command message includes at least one of the following information: a conditional reconfiguration remove list, a conditional reconfiguration addition or modification list including at least one of a conditional reconfiguration identification, a conditional reconfiguration execution condition, a configuration identification and conditional reconfiguration information, and temporary MCG configuration information.

According to an implementation of the disclosure, the handover command list message includes at least one of the following information: a handover command addition or modification list including handover command information, a handover command release list including a handover command information identification, and temporary MCG configuration information.

According to an implementation of the disclosure, the method further includes: performing measurement configuration on a candidate PSCell; and configuring a Conditional PSCell Addition or Change (CPAC) execution condition for the candidate PSCell according to a conditional handover (CHO) execution condition of a candidate MCG primary cell PCell.

According to an implementation of the disclosure, the method further includes: transmitting a fifth message to a user equipment (UE), wherein the fifth message includes measurement report configuration information, or wherein the fifth message includes at least one of the following information: a first conditional reconfiguration identification, a first conditional reconfiguration execution condition, a conditional reconfiguration list including at least one of a second conditional reconfiguration identification and a second conditional reconfiguration execution condition, and conditional reconfiguration information, or wherein the fifth message includes at least one of the following information: a first conditional reconfiguration identification, a first conditional reconfiguration execution condition, a conditional reconfiguration list including at least one of a second conditional reconfiguration identification, a second conditional reconfiguration execution condition, a configuration identification and conditional reconfiguration information, and temporary MCG configuration information, or wherein the fifth message includes at least one of the following information: a first conditional reconfiguration identification, a first conditional reconfiguration execution condition, a conditional reconfiguration read indication, and conditional reconfiguration information.

According to an implementation of the disclosure, the method further includes: transmitting a third message to the first node, wherein the third message includes at least one of the following information: identification information of a user equipment (UE), a candidate target cell identity, and conditional reconfiguration execution condition information of a candidate target cell.

According to various embodiments of the disclosure, a method of handover optimization performed by a user equipment (UE) is provided, including: receiving a fifth message from a second node, wherein the fifth message includes measurement report configuration information, or wherein the fifth message includes at least one of the following information: a first conditional reconfiguration identification, a first conditional reconfiguration execution condition, a conditional reconfiguration list including at least one of a second conditional reconfiguration identification and a second conditional reconfiguration execution condition, and conditional reconfiguration information, or wherein the fifth message includes at least one of the following information: a first conditional reconfiguration identification, a first conditional reconfiguration execution condition, a conditional reconfiguration list including at least one of a second conditional reconfiguration identification, a second conditional reconfiguration execution condition, a configuration identification and conditional reconfiguration information, and temporary MCG configuration information, or wherein the fifth message includes at least one of the following information: a first conditional reconfiguration identification, a first conditional reconfiguration execution condition, a conditional reconfiguration read indication, and conditional reconfiguration information.

According to an implementation of the disclosure, the method further includes: transmitting a fourth message to a first node, wherein the fourth message includes a configuration identification and/or a conditional reconfiguration identification, or the fourth message includes a Cell Radio Network Temporary Identifier (C-RNTI) Media Access Control (MAC) Control Element (CE).

According to various embodiments of the disclosure, a first node is provided, including: a transceiver configured to transmit and receive signals; and a controller coupled with the transceiver and configured to perform the aforementioned methods.

According to various embodiments of the disclosure, a second node is provided, including: a transceiver configured to transmit and receive signals; and a controller coupled with the transceiver and configured to perform the aforementioned methods.

According to various embodiments of the disclosure, a user equipment (UE) is provided, including: a transceiver configured to transmit and receive signals; and a controller coupled with the transceiver and configured to perform the aforementioned methods.

The patent proposes an optimization scheme for handover. When CHO+CPAC is combined, the success rate of CHO+CPAC handover is improved by optimization of the candidate PSCell selection or optimization of the CHO+CPAC execution conditions, thus ensuring the UE to select a suitable target cell, improving the robustness and reliability of UE handover, and further improving the system throughput.

### BRIEF DESCRIPTION OF DRAWINGS

In order to illustrate the technical solution of embodiments of the disclosure more clearly, the drawings of the embodiments will be briefly introduced below, and apparently, the drawings in the following description only relate to some embodiments of the disclosure, but do not limit the disclosure. In the drawings:

FIG. 1 is an exemplary system architecture of system architecture evolution (SAE);

FIG. 2 is an exemplary system architecture according to various embodiments of the disclosure;

FIG. 3 illustrates a flowchart of a method according to various embodiments of the disclosure;

FIG. 4 illustrates a flowchart of a method according to various embodiments of the disclosure;

FIG. 5 illustrates a flowchart of a method according to various embodiments of the disclosure;

FIG. 6 illustrates a flowchart of a method according to various embodiments of the disclosure;

FIG. 7 illustrates a flowchart of a method according to various embodiments of the disclosure;

FIG. 8 illustrates a flowchart of a method according to various embodiments of the disclosure;

FIG. 9 illustrates a block diagram of a configuration of a node according to various embodiments of the disclosure; and

FIG. 10 illustrates a block diagram of a configuration of a UE according to various embodiments of the disclosure.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

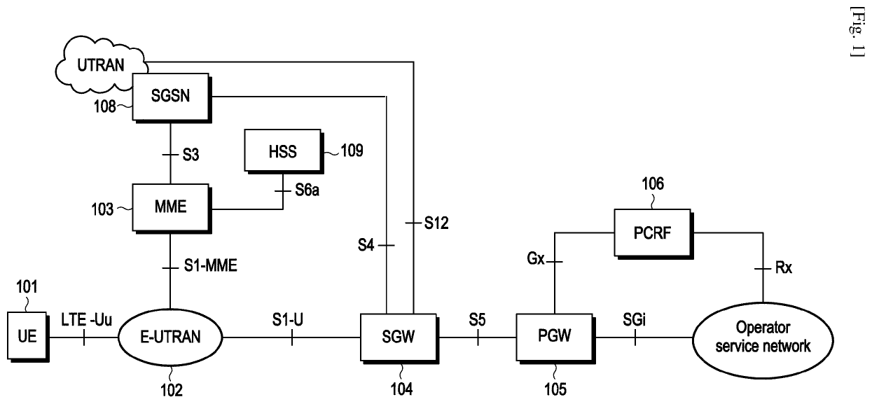

FIGS. 1 to 10 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

Throughout the specification, references to “one embodiment”, “an embodiment”, “one example” or “an example” mean that a specific feature, structure or characteristic described in connection with the embodiment or example is included in at least one embodiment of the disclosure. Therefore, the phrases “in one embodiment”, “in an embodiment”, “one example” or “an example” in various places throughout the specification do not necessarily all refer to the same embodiment or example. Furthermore, specific features, structures or characteristics may be combined in one or more embodiments or examples with any suitable combination and/or sub-combination. Furthermore, it should be understood by those skilled in the art that the drawings provided herein are for illustration purposes and are not necessarily drawn to scale. The term “and/or” used herein includes any and all combinations of one or more related listed items.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

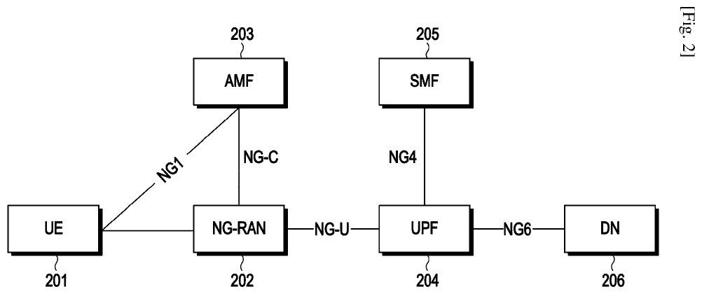

FIG. 2 is an exemplary system architecture 200 according to various embodiments of the disclosure. Other embodiments of the system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties. An interface between the AMF and the NG-RAN is called an NG-C interface, or an NG interface or an N2 interface. An interface between the UPF and the NG-RAN is called an NG-U interface, or an N3 interface, and signaling between the UE and the AMF is called Non-Access Stratum (NAS) signaling, also called an N1 interface. An interface between base stations is called an Xn interface.

Exemplary embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

Detailed illustration of steps irrelevant to the disclosure is omitted in the application. In the following embodiments, a 5G system is taken as an example, a CU is taken as an example of a central unit of an access network, and a DU is taken as an example of a distributed unit for description. The method is also used for corresponding entities of other systems.

In the application, a node may be an entire base station (e.g., gNB, or eNB, or en-gNB, or ng-eNB), a base station including a central unit and a distributed unit, or a base station including a Central Unit Control Plane (CU-CP), a Central Unit-User Plane (CU-UP) and a distributed unit.

In the application, a message name is only an example, and the message may be named by other names. A sequence number of the message does not represent an order in which the message is performed, but only the name of the message.

In NR (New Radio access), Dual Connectivity (DC) is introduced to improve the network performance and single-user traffic, and the performance of the technology is also continuously improved. In the dual connectivity, a UE will be connected with two nodes, one as a Master Node (MN) and the other as a Secondary Node (SN). A group of cells serving the UE in the MN is called a Master Cell Group (MCG), and a group of cells serving the UE in the SN is called a Secondary (Second) Cell Group (SCG). An MCG primary cell is called a PCell (Primary Cell), and a SCG primary cell is called a PSCell (Primary SCG Cell). A CG (Cell group) is a cell group, a CG ID (Cell group identity) is a cell group identity, and an SCG ID is a cell group identity of the SCG.

Conditional Handover (CHO) technology, the base station configures multiple candidate MCG primary cells PCells (i.e., candidate PCells) and an execution condition of the CHO for the UE. The UE monitors the candidate PCells, and when a candidate PCell fulfils the CHO execution condition, the UE selects a suitable PCell to perform handover, thus improving the reliability and robustness of handover.

Under a dual connectivity mechanism, Conditional PSCell Addition (CPA) and Conditional PSCell Change (CPC) technologies are introduced, which are called Conditional PSCell Addition or Change (CPAC) together, to improve the reliability and robustness of addition and change of the SCG primary cell PSCell, thus further improving the service throughput under the dual connectivity. The CPAC may also be represented by CPA/CPC.

A handover method in which CHO is combined with CPAC (CHO plus CPAC or CHO+CPAC for short) will ensure the reliability and robustness of handover and improve the system throughput. The patent proposes an optimization scheme of handover, which ensures that the UE can select and access a suitable target cell, improves the success rate of CHO+CPAC handover, and avoids the impact of the UE's connection interruption with the network on user throughput, when CHO and CPAC are combined. The performance of CHO+CPAC handover is improved, including improving the robustness and reliability of handover and the system throughput. The optimization scheme includes a optimization method of candidate PSCell selection, a optimization method of CHO+CPAC execution conditions and a optimization method of CHO+CPAC handover performing.

In the patent, a master base station in the dual connectivity may also be called a master node (MN). A secondary base station may also be called a secondary node (SN). In a handover process, when a source side is single connectivity, a source base station may also be called a source node; and when the source side is dual connectivity, a source master base station may also be called a source master node (S-MN), and a source secondary base station may also be called a source secondary node (S-SN). A candidate target base station may also be called a candidate target node, or a candidate base station or a candidate node; a new base station selected by the UE may be called a target base station or a target node; and when a target side is dual connectivity, a base station to which a candidate PCell belongs is called a candidate target master base station, or a candidate target master node (T-MN), or a candidate master base station or a candidate master node; a base station to which a candidate PSCell belongs is called a candidate target secondary base station, or a candidate target secondary node (T-SN), or a candidate secondary base station or a candidate secondary node; and during handover, a new master base station selected by the UE may be called a target master base station or a target master node (T-MN); and a new secondary base station selected by the UE may be called a target secondary base station or a target secondary node (T-SN).

The disclosure is suitable for handover when the source side is single base station connectivity and the source side is dual connectivity. The source base station in the following embodiments may be replaced by the source master base station S-MN, and the source master base station S-MN may be replaced by the source base station.

### I. Method of Candidate PSCell Selection

Under a CHO+CPAC mechanism, in a handover preparation stage, the candidate T-MN/T-SN determines the candidate PSCell according to UE measurement results provided by the S-MN. Before handover is performed, with the movement of the UE and the change of the environment, the current link quality of the candidate PSCell will change, which may no longer be suitable as the candidate PSCell of the UE, or there may be a better cell as the candidate PSCell of the UE. In a process in which the handover preparation is completed and the UE starts to perform CHO monitoring or CPAC monitoring according to information in a handover command, the T-MN/T-SN cannot obtain the current link quality information of the candidate PSCell, so the candidate PSCell and its configuration of the UE cannot be adjusted in time. The disclosure proposes a method of candidate PSCell selection, which realize the optimization of the existing candidate PSCell selection and selects a better candidate PSCell for the UE, thereby ensuring that the UE monitors and accesses the most suitable PSCell in the CHO+CPAC process, and improving the handover success rate.

For the problem, the disclosure proposes two solutions to realize the optimization of PSCell selection:

### Selection Method 1 of Candidate PSCell

In the handover preparation stage, the T-MN transmits selected candidate PSCell list information to the S-MN.
The S-MN takes the candidate PSCell as a measurement object and performs measurement configuration. Measurement configuration information includes a measurement identification, a measurement object identification and measurement object information corresponding to the measurement identification, and a measurement report identification and measurement report configuration corresponding to the measurement identification. The measurement report configuration includes a measurement report type (i.e., the measurement report is a periodical report or an event-triggered report), and if the measurement report type is event trigger (e.g., A3 event or A5 event), the measurement report configuration also includes conditions that satisfy the event trigger. The S-MN transmits measurement configuration information to the UE, which measures the measurement object and performs measurement reporting according to requirements of the measurement report configuration.
After receiving the measurement report of the UE, the S-MN may determine whether the current candidate PSCell is suitable to continue as the candidate PSCell and whether there are neighboring cells with link quality satisfying conditions of being the candidate PSCell based on a measurement result, and decide whether to transmit the measurement result to the T-MN. The S-MN may also directly transmit the received measurement result of the UE to the T-MN.
If the T-MN receives the measurement result transmitted by the S-MN, it will decide to newly add a candidate PSCell or cancel the existing candidate PSCell according to the measurement result. If the T-MN modifies the candidate PSCell list information, it provides the updated candidate PSCell list information to the S-MN.

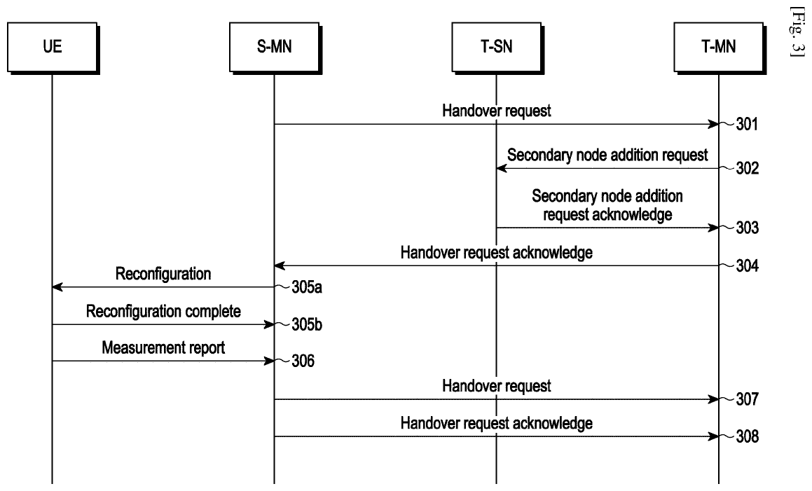

See FIG. 3 for a flow diagram of the selection method 1 of candidate PSCell.

Step 301: the source base station/source master base station transmits a HANDOVER REQUEST message or other messages to the candidate target master base station, indicating that handover is a CHO mechanism, requesting the candidate target base station to take PCell as a candidate cell for UE handover, and performing resource configuration for the UE. The message includes at least one of the following information:
(1) identification information of UE indicating an identification of the UE at the source base station, that is, a source NG-RAN node UE XnAP ID allocated by the source base station.
(2) candidate target cell identity indicating identification information of the candidate target cell for which the source base station requests handover, that is, a Target Cell Global ID, which may be an E-UTRA CGI (E-UTRA Cell Global ID) or NR CGI (NR Cell Global ID). In a mechanism in which CHO and CPAC are combined, the target cell identity is an identity of the candidate primary cell (candidate PCell).
(3) CPAC trigger indication indicating that the T-MN can use the CPAC mechanism to select the candidate PSCell for the UE.
(4) candidate PSCell list information, or measurement result. The S-MN provides the candidate PSCell list information to the T-MN, indicating that the T-MN can select within a range of a candidate PSCell list provided by the S-MN or select the candidate PSCell according to the measurement result.

Step 302: the candidate target master base station T-MN transmits a secondary node addition request message (S-NODE ADDITION REQUEST message or SGNB ADDITION REQUEST message) or other messages to the candidate target secondary base station T-SN, instructing the candidate target secondary base station T-SN to allocate resources for the CPAC process, and provides the measurement result or candidate PSCell list information to the T-SN for the T-SN to select the candidate PSCell.

Step 303: the candidate target secondary base station T-SN transmits a secondary node addition request acknowledge message (S-NODE ADDITION REQUEST ACKNOWLEDGE message or SGNB ADDITION REQUEST ACKNOWLEDGE message) or other messages to the candidate target master base station T-MN. The T-SN transmits the selected candidate PSCell list information and corresponding SCG radio resource configuration information to the T-MN.

Step 304: the candidate target master base station transmits a HANDOVER REQUEST ACKNOWLEDGE message or other messages to the source base station/source master base station. The message includes at least one of the following information:
(1) identification information of UE including an identification of the UE on the source base station/source master base station (Source NG-RAN node UE XnAP ID) and an identification of the UE allocated by the candidate target base station (Target NG-RAN node UE XnAP ID).
(2) requested candidate target cell identity indicating a target cell identity for which handover is requested corresponding to the acknowledge message, which may be an E-UTRA CGI or NR CGI. When CHO+CPAC, the requested candidate target cell is also the candidate PCell. The requested candidate target cell identity is the candidate target cell identity in the corresponding handover request message (step 301).
(3) candidate PSCell list information, which is candidate PSCell list information provided by the T-MN, including at least one of the following information:
Candidate PSCell identity item (Candidate PSCell ID Item) for identifying an information item of each candidate PSCell, and a range of the value is from 1 to the maximum number of candidate PSCells.
SSB frequency information (ssbFrequency) indicating frequency information of a Synchronization Signal Block (SSB) of the candidate PSCell, which may be ARFCN-Value.
Global Cell Identifier (CGI) indicating a cell global identifier of the candidate PSCell, including a PLMN Identity (Public Land Mobile Network Identity) and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.

Step 305a: the source base station/source master base station transmits a reconfiguration message to the terminal UE, and transmits CHO+CPAC configuration information to the UE. It includes measurement configuration, in which measurement report configuration information is included, which may be determined by the S-MN or the T-MN.

The reconfiguration message may be an RRCReconfiguration message, an RRC-ConnectionReconfiguration message, or other messages.

Step 305b: the UE transmits a reconfiguration complete message to the source base station/source master base station, indicating that the UE has saved configuration information of CHO+CPAC.

The reconfiguration complete message may be an RRCReconfigurationComplete message, an RRCConnectionReconfigurationComplete message, or other messages.

Step 306: the UE transmits a measurement report message (MeasurementReport) to the S-MN. When event-triggered reporting or periodical reporting is fulfilled, the UE transmits a measurement report to the S-MN. By the measurement report, the S-MN determines whether the current link quality of the candidate PSCell is suitable as the candidate PSCell, and whether there are neighboring cells with link quality satisfying conditions of being the candidate PSCell, and decides whether to transmit the measurement result to the T-MN, or directly transmit the measurement result of the UE to the T-MN.

Step 307: the S-MN transmits a HANDOVER REQUEST message to the T-MN. The S-MN transmits the received measurement report of the UE to the T-MN. According to the obtained measurement result, the T-MN determines an operation on the candidate PSCell, including canceling the existing candidate PSCell and newly adding a candidate PSCell. If a candidate PSCell list is updated, the T-MN transmits the updated PSCell list information and corresponding updated MCG configuration+SCG configuration (MCG configuration plus SCG configuration, or MCG+SCG configuration, or MCG configuration and SCG configuration, or MCG and SCG configuration) information to the S-MN. In the dual connectivity, the MCG configuration corresponding to the PCell and the SCG configuration corresponding to the PSCell are determined through negotiation between the MN and the SN, thus realizing the joint transmission of UE service data by the MN and the SN and improving the service throughput. Therefore, there is a correspondence (or association) between the PCell and the PSCell, and there is a correspondence (or association) between the MCG configuration and the SCG configuration. Therefore, MCG configuration+SCG configuration represents the MCG configuration and the SCG configuration associated therewith.

Step 308: the T-MN transmits a HANDOVER REQUEST ACKNOWLEDGE message to the S-MN, and the T-MN transmits updated configuration information to the S-SM. The updated configuration information includes the updated candidate PSCell list information and the corresponding updated MCG+SCG configuration information. The content of the candidate PSCell list information is the same as that in step 304, and will not be described here.

### Selection Method 2 of Candidate PSCell

In the handover preparation stage, the T-MN transmits selected candidate PSCell list information and measurement report configuration to the S-MN.
The S-MN takes the candidate PSCell as a measurement object and performs measurement configuration. The measurement configuration includes a measurement identification, a measurement object identification and measurement object information corresponding to the measurement identification, and a measurement report identification and measurement report configuration corresponding to the measurement identification. The measurement report configuration is a measurement report configuration received from the T-MN, which includes a measurement report type (i.e., periodical reporting or event-triggered reporting), and if the measurement report type is event trigger (e.g., A3 event or A5 event), the measurement report configuration also includes conditions that satisfy the event trigger. The S-MN transmits measurement configuration information to the UE, which measures the measurement object and performs measurement reporting according to requirements of the measurement report configuration.
After receiving the measurement report of the UE, the S-MN determines whether the currently selected candidate PSCell is suitable to continue as the candidate PSCell and whether there are neighboring cells with link quality satisfying conditions of being the candidate PSCell based on a measurement result, and decide whether to transmit the measurement result to the T-MN. The S-MN may also directly transmit the received measurement result of the UE to the T-MN.
If the T-MN receives the measurement result transmitted by the S-MN, it will decide to newly add a candidate PSCell or cancel the existing candidate PSCell according to the measurement result.

See FIG. 3 for a flow diagram of the selection method 2 of candidate PSCell. The steps of the method are the same as those of the selection method 1 of candidate PSCell, and the main difference is that in step 304, the handover request acknowledge message or other messages transmitted by the T-MN to the S-MN need to include the measurement report configuration information in addition to the candidate PSCell list information, which is used to indicate a way in which the measurement result of the UE is provided to the S-MN. The measurement report configuration information includes the measurement report type (i.e., the measurement report is a periodical report or an event-triggered report), and if the measurement report type is event trigger (e.g., A3 event or A5 event), the measurement report configuration also includes conditions that satisfy the event trigger. If the measurement report configuration information is included, the S-MN includes the measurement report configuration information received from the T-MN in the measurement configuration information and transmits it to the UE. If the handover request acknowledge message transmitted by the T-MN to the S-MN includes the measurement report configuration information, it may also be used to indicate that the conditions of being the candidate PSCell are decided by the target base station, otherwise by the S-MN.

### II. Optimization Method of CHO+CPAC Execution Conditions

In a CHO+CPAC mechanism, after obtaining a handover configuration, when the UE monitors CHO+CPAC execution conditions, the following cases will occur:
when a CHO execution condition of the candidate PCell is fulfilled, but a CPAC execution condition of the candidate PSCell is not fulfilled;
when the CHO execution condition of the candidate PCell is fulfilled and the CPAC execution condition of the candidate PSCell is fulfilled, but the PCell and the PCell are not associated;
when the CPAC execution condition of the candidate PSCell is fulfilled, but the CHO execution condition of the candidate PCell is not fulfilled.

In the dual connectivity, the MCG configuration corresponding to the PCell and the SCG configuration corresponding to the PSCell are determined through negotiation between the MN and the SN, thus realizing the joint transmission of UE service data by the MN and the SN and improving the service throughput. Therefore, there is a correspondence (or association) between the PCell and the PSCell, and there is a correspondence (or association) between the MCG configuration and the SCG configuration. If the MCG or SCG configuration changes, the corresponding SCG or MCG configuration will also change.

Therefore, in CHO+CPAC, the UE can perform CHO+CPAC handover when the candidate PCell and the candidate PSCell with the association fulfil the CHO execution condition and the CPAC execution condition respectively. If the UE cannot perform the CHO+CPAC handover, it will affect the handover performance and the service transmission throughput of the UE. Therefore, the disclosure proposes an optimization method of a CHO+CPAC execution condition, which can improve the matching degree between the CHO execution condition of the candidate PCell and the CPAC execution condition of the candidate PSCell, and ensure that when the candidate PCell fulfils the CHO execution condition, the CPAC execution condition of the corresponding candidate PSCell can also be fulfilled at the same time, thereby improving the success rate of CHO+CPAC handover.

At present, the execution conditions of CHO and CPAC are configured in the S-MN and the T-MN respectively, so the matching degree between the CHO execution condition of the PCell and the CPAC execution condition of the PSCell is not ideal, which leads to the possibility that the CHO execution condition of the candidate PCell and the CPAC execution condition of the candidate PSCell cannot be fulfilled at the same time.

The disclosure proposes two optimization methods of CHO+CPAC execution conditions, which are specifically described as follows.
Optimization Method 1 of CHO+CPAC Execution Conditions:

In the method, the CHO execution condition of the candidate PCell and the CPAC execution condition of the candidate PSCell are uniformly set by the S-MN. That is, the S-MN sets the CPAC execution condition for the candidate PSCell corresponding to the candidate PCell while setting the CHO execution condition for the candidate PCell, thereby ensuring the matching of the CHO execution condition of the candidate PCell and the CPAC execution condition of the candidate PSCell.

When the candidate PCell fulfils the CHO execution condition and its corresponding candidate PSCell fulfils the CPAC execution condition, the UE will perform the CHO+CPAC handover, and access the target PCell and the target PSCell using the MCG configuration and SCG configuration provided by the target node. In CHO+CPAC, there will be multiple candidate PCells which correspond to multiple candidate PSCells, so multiple MCG configuration and SCG configuration information (MCG+SCG configuration information) will be generated. Because the CHO execution condition of the candidate PCell and the CPAC execution condition of the candidate PSCell (abbreviated as execution condition) are generated by the S-MN, while the MCG and SCG configuration information corresponding to the candidate PCell and PSCell is provided by the T-MN, how to correspond the MCG and SCG information configured by the T-MN and the execution conditions set by the S-MN and provide them to the UE, so that the UE can accurately obtain the MCG and SCG configuration information and configure and use it is a problem to be solved. For the problem, the disclosure proposes two transmission modes of configuration information, which transmit the configuration information to the UE, so as to realize the correspondence between the MCG and SCG information configured by the T-MN and the execution conditions set by the S-MN. Therefore, while optimizing the CHO+CPAC execution conditions, the correct transmission of the configuration information is ensured.

Since the MCG and SCG configuration corresponding to the candidate PCell and the candidate PSCell is completed at the candidate target base station, and the execution conditions are configured at the S-MN, the transmission of the MCG and SCG configuration information transmitted to the UE includes two steps: the T-MN transmits the MCG configuration and SCG configuration information to the S-MN, and the S-MN transmits the MCG configuration and SCG configuration information from the T-MN to the UE in combination with the execution conditions. The specific contents of the transmission information in each step in the two configuration information transmission methods are described below respectively.

### Configuration Information Transmission Method 1

In the method 1, the T-MN transmits multiple MCG+SCG configurations to the S-MN in one handover command, which does not include the CPAC execution condition of the candidate PSCell. The S-MN directly transmits the handover command to the UE.

(1) The T-MN transmits configuration information to the S-MN.

The T-MN transmits a handover request acknowledge message to the S-MN, which includes:
requested target cell identity (Requested Target Cell ID), which is an identity of a candidate target primary cell PCell for which handover is requested in CHO+CPAC handover.
candidate PSCell list information, which is candidate PSCell list information provided by the T-MN and includes information of the candidate PSCell, including:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.
handover command message (HandoverCommand)

The handover command message includes resource configuration information prepared by the candidate target base station/candidate target secondary base station for UE handover. When CHO+CPAC, each candidate PCell may correspond to multiple candidate PSCells, and each PSCell corresponds to a different SCG configuration, so the candidate PCell and different candidate PSCell will correspond to one MCG+SCG configuration. When corresponding to multiple candidate PSCells, the same candidate PCell will correspond to multiple MCG+SCG configuration information.

Therefore, MCG and SCG configuration information corresponding to the PCell and different PSCells may be provided in the handover command message according to the PSCell identity. The handover command message is transmitted by the T-MN to the UE, so the S-MN will not disassemble the contents in the handover command message. The HandoverCommand includes:
conditional reconfiguration remove list (condReconfigToRemoveList) including conditional reconfiguration identifications to be removed, which correspond to candidate PSCell identities. If the conditional reconfiguration identifications corresponding to the candidate PSCell identities are included in the conditional reconfiguration remove list, it indicates to remove the cell from the candidate PSCell list.
conditional reconfiguration addition or modification list (condReconfigToAddModList) including multiple MCG and SCG configuration information. It includes:
conditional reconfiguration identification (condReconfigId) corresponding to the candidate PSCell identity.
conditional configuration (condRRCReconfig) information, which is an RRC reconfiguration message (RRCReconfiguration) transmitted to the UE, including an MCG and SCG configuration information to the UE. The MCG and SCG configuration information respectively corresponds to the candidate PCell and the candidate PSCell. The candidate PCell is the requested target cell identity included in the handover request acknowledge message transmitted by the T-MN to the S-MN; and the candidate PSCell is a candidate cell corresponding to the conditional reconfiguration identification.

(2) The S-MN transmits CHO+CPAC handover configuration information to the UE.

The S-MN configures the CPAC execution condition for the candidate PSCell according to information on the candidate PSCell in the handover request acknowledge message received from the T-MN, in combination with the CHO execution condition of the PCell, and configures the conditional configuration identification (condReconfigId) for the candidate PSCell, and transmits the CHO+CPAC handover configuration information to the UE through the RRC reconfiguration message, which includes:
first conditional reconfiguration identification corresponding to the candidate PCell identity.
first conditional reconfiguration execution condition (condExecutionCond), which is a CHO execution condition of the candidate PCell configured by the S-MN.
conditional reconfiguration list, which includes:
second conditional reconfiguration identification corresponding to the candidate PSCell identity, which may be configured by the T-MN or by the S-MN.
second conditional reconfiguration execution condition, which is a CPAC execution condition of the candidate PSCell configured by the S-MN.
conditional reconfiguration (condRRCReconfig) information, which is a handover command message (HandoverCommand) transmitted by the T-MN to the S-MN, including multiple MCG and SCG configuration information allocated by the T-MN to the UE.

### Configuration Information Transmission Method 2

In the method 2, the T-MN transmits multiple MCG+SCG configurations to the S-MN in a form of a handover command list, and then the S-MN provides them to the UE in a way that the CHO+CPAC execution conditions correspond to the MCG+SCG configurations.

(1) The T-MN transmits configuration information to the S-MN.

The T-MN transmits a handover request acknowledge message to the S-MN, in which multiple MCG and SCG configuration information are provided to the S-MN in a form of a list, and the message includes:
requested candidate target cell identity (Requested Target Cell ID), where the requested candidate target cell is the candidate PCell.
handover command list message (HandoverCommandList message), which includes:
handover command addition or modification list (HandoverCommandToAddModList), which includes:
handover command information (HandoverCommandInfo) including an MCG and SCG configuration information corresponding to the candidate PSCell associated with the PCell. The candidate PCell is a cell corresponding to the “requested candidate target cell identity”. The handover command information includes:
handover command information identification (HandoverCommandInfoId), that is, candidate PSCell information corresponding to the handover command, which includes:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.
handover command message (HandoverCommand) including an MCG+SCG configuration information, which corresponds to the candidate PSCell, where information of the candidate PSCell is included in the handover command information identification.
handover command release list (HandoverCommandToReleaseList) including handover command information identification (HandoverCommandInfoId).

(2) The S-MN transmits CHO+CPAC handover configuration information to the UE.

According to information in the handover request acknowledge message received from the T-MN, the S-MN configures the CPAC execution condition for the PSCell, and configures the conditional reconfiguration identification (condReconfigId) for the candidate PSCell, and transmits the CHO+CPAC handover configuration information to the UE through an RRC reconfiguration message, which includes:
first conditional reconfiguration identification corresponding to the candidate PCell identity.
first conditional reconfiguration execution condition, which is a CHO execution condition of the candidate PCell configured by the S-MN.
conditional reconfiguration list, which includes:
second conditional reconfiguration identification corresponding to the candidate PSCell identity, which may be configured by the T-MN or by the S-MN.
second conditional reconfiguration execution condition, which is a CPAC execution condition of the candidate PSCell configured by the S-MN.
conditional reconfiguration (condRRCReconfig) information, which is a handover command (handovercommand) message corresponding to HandoverCommandinfold in the handover command list message (HandoverCommandList message) transmitted by the T-MN to the S-MN, which corresponds to an MCG and SCG configuration information.

Through the above two methods, it can be ensured that the UE can correctly obtain the execution conditions and configuration information corresponding thereto. By the matching of the execution conditions, the success rate of the handover is ensured.

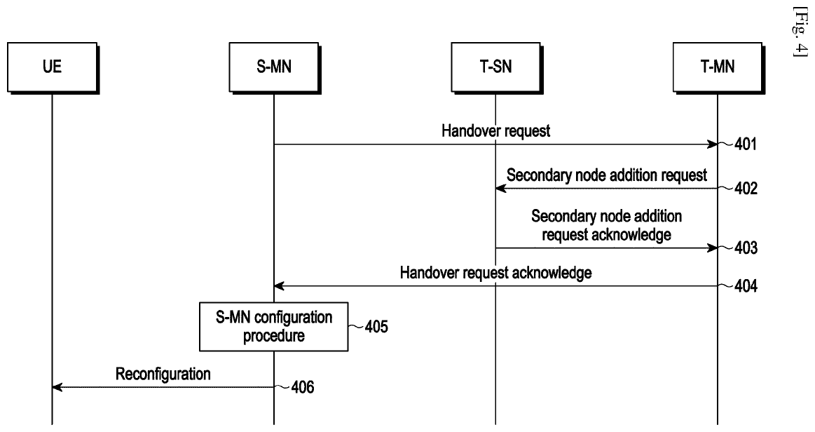

When the configuration information transmission method 1 is used, a flow of the optimization method 1 of CHO+CPAC execution conditions is shown in FIG. 4.

Step 401: the source base station/source master base station transmits a HANDOVER REQUEST message or other messages to the candidate target master base station, indicating that handover is a CHO mechanism, requesting the candidate target base station to take PCell as a candidate cell for UE handover, and performing resource configuration for the UE. The message includes at least one of the following information:
(1) identification information of UE indicating an identification of the UE at the source base station/source master base station, that is, a source NG-RAN node UE XnAP ID allocated by the source base station/source master base station.
(2) candidate target cell identity indicating identification information of the candidate target cell for which the source base station/source master base station requests handover, that is, a Target Cell Global ID, which may be an E-UTRA CGI or NR CGI. In a mechanism in which CHO and CPAC are combined, it is the candidate primary cell (candidate PCell).

Step 402: the candidate target master base station T-MN transmits a secondary node addition request message (S-NODE ADDITION REQUEST message or SGNB ADDITION REQUEST message) or other messages to the candidate target secondary base station T-SN, instructing the candidate target secondary base station T-SN to allocate necessary resources for the CPAC process, and provides the measurement result or candidate PSCell list information to the T-SN for the T-SN to select and determine a final list of candidate PSCells.

Step 403: the candidate target secondary base station T-SN transmits a secondary node addition request acknowledge message (S-NODE ADDITION REQUEST ACKNOWLEDGE message or SGNB ADDITION REQUEST ACKNOWLEDGE message) or other messages to the candidate target master base station T-MN. The message includes candidate PSCell list information selected by the T-SN for the CPAC process and corresponding SCG radio resource configuration information.

Step 404: the candidate target master base station transmits a HANDOVER REQUEST ACKNOWLEDGE message or other messages to the source base station/source master base station, which is used to transmit CHO and CPAC related information configured by each candidate target master base station for the UE, and candidate PSCell information. The message includes at least one of the following information:
(1) identification information of UE including an identification of the UE on the source base station/source master base station (Source NG-RAN node UE XnAP ID) and an identification of the UE allocated by the candidate target base station (Target NG-RAN node UE XnAP ID).
(2) requested candidate target cell identity indicating a target cell identity for which handover is requested corresponding to the acknowledge message, which may be an E-UTRA CGI or NR CGI. When CHO+CPAC, the requested candidate target cell is also the candidate PCell. The requested candidate target cell identity is the candidate target cell identity in the corresponding handover request message (step 401).
(3) candidate target base station to source base station container, that is, a Target NG-RAN node To Source NG-RAN node Transparent Container, including the handover command message (HandoverCommand message), which includes resource configuration information prepared by the candidate target base station/candidate target secondary base station for UE handover. When CHO+CPAC, each candidate PCell may correspond to multiple candidate PSCells, and each PSCell corresponds to a different SCG configuration, so the candidate PCell and different candidate PSCell will correspond to one MCG+SCG configuration. When corresponding to multiple candidate PSCells, the same candidate PCell will correspond to multiple MCG+SCG configuration information. Therefore, the MCG and SCG configuration information corresponding to the PCell and different PSCells will be provided in the handover command message according to the PSCell identity. The handover command message is transmitted by the T-MN to the UE, so the S-MN will not disassemble the contents in the handover command message. The HandoverCommand includes at least one of the following information:
conditional reconfiguration remove list (condReconfigToRemoveList) including conditional reconfiguration identifications to be removed, which correspond to candidate PSCell identities. If the conditional reconfiguration identifications corresponding to the candidate PSCell identities are included in the conditional reconfiguration remove list, the cell is removed from the candidate PSCell list.
conditional reconfiguration addition or modification list (condReconfigToAddModList) including multiple MCG and SCG configuration information. At least one of the following information is included:
conditional reconfiguration identification (condReconfigId) corresponding to the candidate PSCell identity.
conditional configuration (condRRCReconfig) information, which is an RRC reconfiguration message (RRCReconfiguration) transmitted to the UE, including an MCG and SCG configuration information to the UE. The MCG and SCG configuration information respectively corresponds to the candidate PCell and the candidate PSCell. The candidate PCell is the requested target cell identity included in the handover request acknowledge message transmitted by the T-MN to the S-MN; and the candidate PSCell is a candidate cell corresponding to the conditional reconfiguration identification.

(4) candidate PSCell list information, which is candidate PSCell list information provided by the T-MN, including at least one of the following information:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.

Step 405: the source master base station S-MN takes the candidate PSCell obtained in step 404 as a measurement object, performs measurement configuration, and configures a suitable CPAC execution condition for the candidate PSCell according to the CHO execution condition of the candidate PCell. Therefore, the CHO execution condition of the candidate PCell and the CPAC execution condition of the candidate PSCell are matched, and the CHO+CPAC execution conditions are optimized. The candidate PSCell is configured with the conditional reconfiguration identification (condReconfigId), which may be set by the T-MN for the candidate PSCell and provided to the S-MN.

Step 406: the source base station/source master base station transmits a reconfiguration message to the terminal UE, and transmits the CHO+CPAC handover configuration information to the UE. The message includes at least one of the following information:
first conditional reconfiguration identification (condReconfigId) corresponding to the candidate PCell identity
first conditional reconfiguration execution condition (condExecutionCond), which is a CHO execution condition of the candidate PCell configured by the S-MN
conditional reconfiguration list, which includes:
second conditional reconfiguration identification (condReconfigId) corresponding to the candidate PSCell identity. If the T-MN includes a reconfiguration identification in the candidate PSCell list information of the handover request acknowledge message in step 404, the second conditional reconfiguration identification will adopt the reconfiguration identification.
second conditional reconfiguration execution condition (condExecutionCond), which is a CPAC execution condition of the candidate PSCell configured by the S-MN
conditional reconfiguration (condRRCReconfig) information, which is a handover command message (HandoverCommand) transmitted by the T-MN to the S-MN, including multiple MCG and SCG configuration information allocated by the T-MN to the UE.

The reconfiguration message may be an RRCReconfiguration message, an RRC-ConnectionReconfiguration message, or other messages.

When the configuration information transmission method 2 is used, a flow of the optimization method 1 of CHO+CPAC execution conditions is shown in FIG. 4. The steps are the same as when the configuration information transmission method 1 is used, but the difference is in the message structure of steps 404 and 406, as follows:

Step 404: the candidate target master base station transmits a HANDOVER REQUEST ACKNOWLEDGE message or other messages to the source base station/source master base station, which is used to transmit CHO and CPAC related information configured by each candidate target master base station for the UE, and candidate PSCell information. The message includes at least one of the following information:
(1) identification information of UE including an identification of the UE on the source base station/source master base station (Source NG-RAN node UE XnAP ID) and an identification of the UE allocated by the candidate target base station (Target NG-RAN node UE XnAP ID).
(2) requested candidate target cell identity indicating a target cell identity for which handover is requested corresponding to the acknowledge message, which may be an E-UTRA CGI or NR CGI. When CHO+CPAC, the requested candidate target cell is also the candidate PCell. The requested candidate target cell identity is the candidate target cell identity in the corresponding handover request message (step 401).
(3) candidate target base station to source base station container, that is, a Target NG-RAN node To Source NG-RAN node Transparent Container, which includes the handover command list message (HandoverCommandList message), in which multiple MCG and SCG configuration information are provided in a form of a list, where at least one of the following information is included:
handover command addition or modification list (HandoverCommandToAddModList), which includes:
handover command information (HandoverCommandInfo) including an MCG and SCG configuration information corresponding to the candidate PSCell associated with the PCell. The candidate PCell is a cell corresponding to the “requested candidate target cell identity”. At least one of the following information is included:
handover command information identification (HandoverCommandInfoId), that is, candidate PSCell information corresponding to the handover command, which includes at least one of the following information:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.
handover command message (HandoverCommand) including an MCG+SCG configuration information, which corresponds to the candidate PSCell, where information of the candidate PSCell is included in the handover command information identification.
handover command release list (HandoverCommandToReleaseList) including handover command information identifications to be removed (HandoverCommandInfoId).

Step 406: the source base station/source master base station transmits a reconfiguration message to the terminal UE, and transmits the CHO+CPAC handover configuration information to the UE. The message includes at least one of the following information:
first conditional reconfiguration identification (condReconfigId) corresponding to the candidate PCell identity
first conditional reconfiguration execution condition (condExecutionCond), which is a CHO execution condition of the candidate PCell configured by the S-MN
conditional reconfiguration list, which includes:
second conditional reconfiguration identification (condReconfigId) corresponding to the candidate PSCell identity. If the T-MN includes a reconfiguration identification in the handover command information identification of the handover request acknowledge message in step 404, the second conditional reconfiguration identification will adopt the reconfiguration identification;
second conditional reconfiguration execution condition (condExecutionCond), which is a CPAC execution condition of the candidate PSCell configured by the S-MN;
conditional reconfiguration (condRRCReconfig) information, which is a handover command (handovercommand) message corresponding to HandoverCommandinfoId in the handover command list message (HandoverCommandList message) transmitted by the T-MN to the S-MN, which corresponds to an MCG and SCG configuration information.

The reconfiguration message may be an RRCReconfiguration message, an RRC-ConnectionReconfiguration message, or other messages.

### Optimization Method 2 of CHO+CPAC Execution Conditions

In the method, the T-MN sets the CPAC execution condition for the candidate PCell corresponding to the candidate PCell based on the CHO execution conditions set by the S-MN for the candidate PCell, thereby ensuring the matching degree between the CHO execution condition of the PCell and the CPAC execution condition of the PSCell.

How to associate the CHO execution condition of the candidate PCell set by the S-MN with the CPAC execution condition of the candidate PSCell set by the T-MN, and how to correspond the execution conditions with the MCG and SCG information configured by the T-MN and provide them to the UE, so that the UE can accurately obtain the information and configure and use it is a problem to be solved.

For the problem, the disclosure proposes two methods of transmitting configuration information to the UE, so as to realize the association between the CHO execution condition of the candidate PCell set by the S-MN and the CPAC execution condition of the candidate PSCell set by the T-MN, and to correspond the execution conditions with the MCG and SCG information configured by the T-MN. Therefore, while optimizing the execution conditions of CHO+CPAC, the correct transmission of configuration information is ensured.

Because the MCG configuration and SCG configuration corresponding to the candidate PCell and the candidate PSCell and the setting of the CPAC execution condition of the candidate PSCell are completed at the candidate target node, and the CHO execution condition is configured at the S-MN, the transmission of the configuration information and the CPAC execution condition of the candidate PSCell to the UE includes two steps: the T-MN transmits the MCG configuration and SCG configuration and the CPAC execution condition of the candidate PSCell to the S-MN, and the S-MN transmits the MCG configuration and SCG configuration and the CPAC execution condition of the candidate PSCell from the T-MN to the UE in combination with the CHO execution condition. There are two methods to transmit the configuration information to the UE:

### Configuration Information Transmission Method 1

In the method 1, the T-MN transmits multiple MCG+SCG configurations to the S-MN in a handover command, which includes the CPAC execution condition of the candidate PSCell. The S-MN directly transmits the handover command to the UE.

(1) The T-MN transmits configuration information to the S-MN.

The T-MN transmits a handover request acknowledge message to the S-MN, which includes:
requested target cell identity (Requested Target Cell ID), which is an identity of a candidate target primary cell PCell for which handover is requested in CHO+CPAC.
handover command message (HandoverCommand)

The handover command message includes resource configuration information prepared by the candidate target base station/candidate target secondary base station for UE handover. When CHO+CPAC, each candidate PCell may correspond to multiple candidate PSCells, and each PSCell corresponds to a different SCG configuration, so the candidate PCell and different candidate PSCell will correspond to one MCG+SCG configuration. When corresponding to multiple candidate PSCells, the same candidate PCell will correspond to multiple MCG+SCG configuration information.

Therefore, the MCG and SCG configuration information corresponding to the PCell and different PSCells will be provided in the handover command message according to the PSCell identity. The handover command message is transmitted by the T-MN to the UE, so the S-MN will not disassemble the contents in the handover command message. The HandoverCommand includes:
conditional reconfiguration remove list (condReconfigToRemoveList) including conditional reconfiguration identifications to be removed, which correspond to candidate PSCell identities. If the conditional reconfiguration identifications corresponding to the candidate PSCell identities are included in the conditional reconfiguration remove list, the cell is removed from the candidate PSCell list.
conditional reconfiguration addition or modification list (condReconfigToAddModList) including multiple MCG and SCG configuration information. It includes:
conditional reconfiguration identification (condReconfigId) corresponding to the candidate PSCell identity.
conditional reconfiguration execution condition (condExcutionCond), which is a CPAC execution condition of the candidate PSCell and is set by the T-MN based on the CHO execution condition of the PCell configured by the S-MN. The CHO execution condition of the PCell configured by the S-MN is included in a handover request message transmitted by the S-MN to the T-MN.
conditional configuration (condRRCReconfig) information, which is an RRC reconfiguration message (RRCReconfiguration) transmitted to the UE, including an MCG and SCG configuration information to the UE. The MCG and SCG configuration information respectively corresponds to the candidate PCell and the candidate PSCell. The candidate PCell is the requested target cell identity included in the handover request acknowledge message transmitted by the T-MN to the S-MN; and the candidate PSCell is a candidate cell corresponding to the conditional reconfiguration identification.

(2) The S-MN transmits CHO+CPAC handover configuration information to the UE.

According to information in the handover request acknowledge message received from the T-MN, configuring the CPAC execution condition for the candidate PSCell, and the conditional reconfiguration identification (condReconfigId) for the candidate PSCell, the S-MN transmits the configuration information to the UE through an RRC reconfiguration message. It includes:
conditional reconfiguration identification corresponding to the candidate PCell identity
conditional reconfiguration execution condition (condExecutionCond), which is a CHO execution condition of the candidate PCell
conditional reconfiguration read indication. The conditional reconfiguration read indication is optional. If it is included in the RRC reconfiguration message, it instructs the UE to acquire CPAC-related configuration information of the candidate PSCell in the “conditional reconfiguration” after receiving the RRC reconfiguration message, including the conditional reconfiguration identification corresponding to each candidate PSCell, the conditional reconfiguration execution condition and the conditional reconfiguration. The UE performs monitoring CPAC of the PSCell based on the obtained conditional reconfiguration identification corresponding to the candidate PSCell and the conditional reconfiguration execution condition, and simultaneously with monitoring of CHO of the PCell corresponding to the PSCell.
conditional reconfiguration (condRRCReconfig) information, which is a handover command message (HandoverCommand) transmitted by the T-MN to the S-MN, including multiple MCG and SCG configuration information allocated by the T-MN to the UE.

### Configuration Information Transmission Method 2

In the method 2, the T-MN transmits multiple MCG+SCG configuration information and the CPAC execution condition of the candidate PSCell to the S-MN in a format of a handover command list, and then the S-MN provides them to the UE in a way in which CHO+CPAC execution conditions correspond to MCG+SCG configurations.

(1) The T-MN transmits configuration information to the S-MN.

The T-MN transmits a handover request acknowledge message to the S-MN, in which multiple MCG and SCG configuration information are provided in a form of a list, and the message includes:
requested candidate target cell identity (Requested Target Cell ID), where the requested candidate target cell is the candidate PCell.
handover command list message (HandoverCommandList message), which includes:
handover command addition or modification list (HandoverCommandToAddModList), which includes:
handover command information (HandoverCommandInfo) including an MCG and SCG configuration information corresponding to the candidate PSCell associated with the PCell. The candidate PCell is a cell corresponding to the “requested candidate target cell identity”. The handover command information includes:
handover command information identification (HandoverCommandInfoId), that is, candidate PSCell information corresponding to the handover command, which includes:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.
conditional reconfiguration execution condition (condExcutionCond), which is a CPAC execution condition of the candidate PSCell and is set by the T-MN based on the CHO execution condition of the PCell configured by the S-MN. The CHO execution condition of the PCell configured by the S-MN is included in a handover request message transmitted by the S-MN to the T-MN.
handover command message (HandoverCommand) including an MCG+SCG configuration information, which corresponds to the PSCell.
handover command release list (HandoverCommandToReleaseList) including handover command information identification (HandoverCommandInfoId)

(2) The S-MN transmits CHO+CPAC handover configuration information to the UE.

According to information in the handover request acknowledge message received from the T-MN, configuring the CPAC execution condition for the PSCell, and the conditional reconfiguration identification (condReconfigId) for the candidate PSCell, the S-MN transmits the configuration information to the UE through an RRC reconfiguration message. It includes:
first conditional reconfiguration identification corresponding to the candidate PCell identity
first conditional reconfiguration execution condition, which is a CHO execution condition of the candidate PCell
conditional reconfiguration list, which includes:
second conditional reconfiguration identification corresponding to the candidate PSCell identity
second conditional reconfiguration execution condition, which is a CPAC execution condition of the candidate PSCell
conditional reconfiguration (condRRCReconfig) information, which is a handover command (handovercommand) message corresponding to HandoverCommandinfoId in the handover command list message (HandoverCommandList message) transmitted by the T-MN to the S-MN, which corresponds to an MCG and SCG configuration information.

Through the above two methods, it can be ensured that the UE can correctly obtain the execution conditions and configuration information corresponding thereto. By the matching of the execution conditions, the success of handover is ensured.

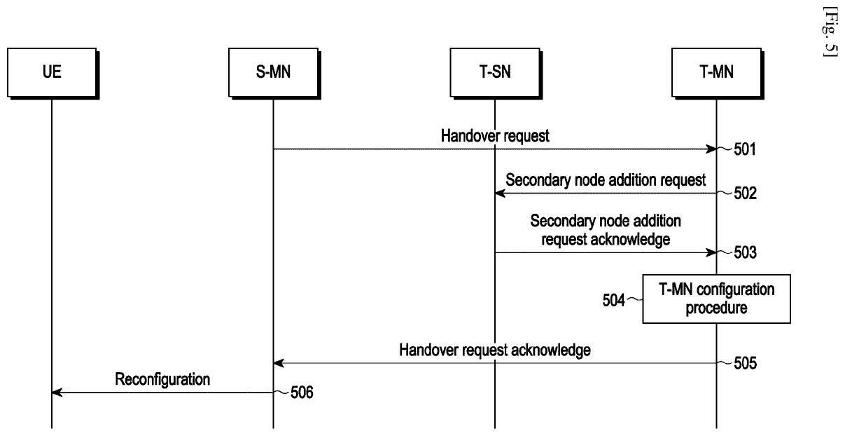

When the configuration information transmission method 1 is used, a flow of the optimization method 2 of CHO+CPAC execution conditions is shown in FIG. 5. In which,

Step 501: the source base station/source master base station transmits a HANDOVER REQUEST message or other messages to the candidate target master base station, indicating that handover is a CHO mechanism, requesting the candidate target base station to take PCell as a candidate cell for UE handover, and performing resource configuration for the UE. The message includes at least one of the following information:
(1) identification information of UE indicating an identification of the UE at the source base station/source master base station, that is, a source NG-RAN node UE XnAP ID allocated by the source base station/source master base station.
(2) candidate target cell identity indicating identification information of the candidate target cell for which the source base station requests handover, that is, a Target Cell Global ID, which may be an E-UTRA CGI or NR CGI. Under a mechanism in which CHO and CPAC are combined, it is the candidate primary cell (candidate PCell).
(3) conditional reconfiguration execution condition information of candidate target cell providing CHO execution condition information of the candidate PCell requesting handover. The T-MN sets the CPAC execution condition of the candidate PSCell corresponding to the candidate PCell based on the conditional reconfiguration execution condition information of candidate target cell.

Step 502: the candidate target master base station T-MN transmits a secondary node addition request message (S-NODE ADDITION REQUEST message or SGNB ADDITION REQUEST message) or other messages to the candidate target secondary base station T-SN, instructing the candidate target secondary base station T-SN to allocate necessary resources for the CPAC process, and provides the measurement result or candidate PSCell list information to the T-SN for the T-SN to select a list of candidate PSCells.

Step 503: the candidate target secondary base station T-SN transmits a secondary node addition request acknowledge message (S-NODE ADDITION REQUEST ACKNOWLEDGE message or SGNB ADDITION REQUEST ACKNOWLEDGE message) or other messages to the candidate target master base station T-MN. The message includes candidate PSCell list information and corresponding SCG radio resource configuration information.

Step 504: the T-MN configures the CPAC execution condition for the candidate PSCell according to the obtained CHO execution condition of the candidate PCell configured by the S-MN in step 501, so as to realize the matching of the CHO execution condition of the PCell and the CPAC execution condition of the PSCell, optimize CHO+CPAC execution conditions, and configure the conditional reconfiguration identification (condReconfigId) for the candidate PSCell.

Step 505: the candidate target master base station transmits a HANDOVER REQUEST ACKNOWLEDGE message or other messages to the source base station/source master base station, which is used to transmit CHO and CPAC related information configured by each candidate target master base station for the UE, and candidate PSCell information. The message includes at least one of the following information:
(1) identification information of UE including an identification of the UE on the source base station (Source NG-RAN node UE XnAP ID) and an identification of the UE allocated by the candidate target base station (Target NG-RAN node UE XnAP ID).
(2) requested candidate target cell identity indicating a target cell identity for which handover is requested corresponding to the acknowledge message, which may be an E-UTRA CGI or NR CGI. When CHO+CPAC, the requested candidate target cell is also the candidate PCell. The requested candidate target cell identity is the candidate target cell identity in the corresponding handover request message (step 501).
(3) candidate target base station to source base station container, that is, a Target NG-RAN node To Source NG-RAN node Transparent Container, which includes the handover command message (HandoverCommand message), and resource configuration information prepared by the candidate target base station/candidate target secondary base station for UE handover. When CHO+CPAC, each candidate PCell may correspond to multiple candidate PSCells, and each PSCell corresponds to a different SCG configuration, so the candidate PCell and different candidate PSCell will correspond to one MCG+SCG configuration. When corresponding to multiple candidate PSCells, the same candidate PCell will correspond to multiple MCG+SCG configuration information. Therefore, the MCG and SCG configuration information corresponding to the PCell and different PSCells will be provided in the handover command message according to the PSCell identity. The handover command message is transmitted by the T-MN to the UE, so the S-MN will not disassemble the contents in the handover command message. The HandoverCommand includes at least one of the following information:
conditional reconfiguration remove list (condReconfigToRemoveList) including conditional reconfiguration identifications to be removed, which correspond to candidate PSCell identities. If the conditional reconfiguration identifications corresponding to the candidate PSCell identities are included in the conditional reconfiguration remove list, the cell is removed from the candidate PSCell list.
conditional reconfiguration addition or modification list (condReconfigToAddModList) including multiple MCG and SCG configuration information. At least one of the following information is included:
conditional reconfiguration identification (condReconfigId) corresponding to the candidate PSCell identity.
conditional reconfiguration execution condition (condExcutionCond), which is a CPAC execution condition of the candidate PSCell and is set by the T-MN based on the CHO execution condition of the PCell configured by the S-MN. The CHO execution condition of the PCell configured by the S-MN is included in a handover request message transmitted by the S-MN to the T-MN.
conditional configuration (condRRCReconfig) information, which is an RRC reconfiguration message (RRCReconfiguration) transmitted to the UE, including an MCG and SCG configuration information to the UE. The MCG and SCG configuration information respectively corresponds to the candidate PCell and the candidate PSCell. The candidate PCell is the requested target cell identity included in the handover request acknowledge message transmitted by the T-MN to the S-MN; and the candidate PSCell is a candidate cell corresponding to the conditional reconfiguration identification.

(4) candidate PSCell list information, which is candidate PSCell list information provided by the T-MN, including at least one of the following information:
candidate PSCell identity item (Candidate PSCell ID Item) for identifying an information item of each candidate PSCell, and a range of the value is from 1 to the maximum number of candidate PSCells.
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;

Step 506: the source base station/source master base station transmits a reconfiguration message to the terminal UE, and transmits the CHO+CPAC handover configuration information to the UE. The message includes at least one of the following information:
conditional reconfiguration identification (condReconfigId) corresponding to the candidate PCell identity
conditional reconfiguration execution condition (condExecutionCond), which is a CHO execution condition of the candidate PCell
conditional reconfiguration read indication. The conditional reconfiguration read indication is optional. If it is included in the RRC reconfiguration message, it instructs the UE to acquire related configuration information of the candidate PSCell in the “conditional reconfiguration information” after receiving the RRC reconfiguration message, including the conditional reconfiguration identification corresponding to each candidate PSCell and the conditional reconfiguration execution condition (CPAC execution condition). The UE monitors whether the candidate PSCell fulfils the CPAC execution condition based on the obtained conditional reconfiguration identification corresponding to the candidate PSCell and the conditional reconfiguration execution condition, and simultaneously with monitoring whether the candidate PCell fulfils the CHO execution condition.
conditional reconfiguration (condRRCReconfig) information, which is a handover command message (HandoverCommand) transmitted by the T-MN to the S-MN, including multiple MCG and SCG configuration information allocated by the T-MN to the UE.

The reconfiguration message may be an RRCReconfiguration message, an RRC-ConnectionReconfiguration message, or other messages.

When the configuration information transmission method 2 is used, a flow of the optimization method 2 of CHO+CPAC execution conditions is shown in FIG. 5. The steps are the same as when the configuration information transmission method 1 is used, but the difference is in the message structure of steps 505 and 506, as follows:

Step 505: the candidate target master base station transmits a HANDOVER REQUEST ACKNOWLEDGE message or other messages to the source base station/source master base station, which is used to transmit CHO and CPAC related information configured by each candidate target master base station for the UE, and candidate PSCell information. The message includes at least one of the following information:
(1) identification information of UE including an identification of the UE on the source base station (Source NG-RAN node UE XnAP ID) and an identification of the UE allocated by the candidate target base station (Target NG-RAN node UE XnAP ID).
(2) requested candidate target cell identity indicating a target cell identity for which handover is requested corresponding to the acknowledge message, which may be an E-UTRA CGI or NR CGI. When CHO+CPAC, the requested candidate target cell is also the candidate PCell. The requested candidate target cell identity is the candidate target cell identity in the corresponding handover request message (step 501).
(3) candidate target base station to source base station container, that is, a Target NG-RAN node To Source NG-RAN node Transparent Container, which includes a handover command list (HandoverCommandList) message, in which multiple MCG and SCG configuration information are provided in a form of a list, including at least one of the following information:
handover command addition or modification list (HandoverCommandToAddModList), which includes:
handover command information (HandoverCommandInfo) including an MCG and SCG configuration information corresponding to the candidate PSCell associated with the PCell. The candidate PCell is a cell corresponding to the “requested candidate target cell identity”. At least one of the following information is included:
handover command information identification (HandoverCommandInfoId), that is, candidate PSCell information corresponding to the handover command, which includes at least one of the following information:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.
conditional reconfiguration execution condition (condExcutionCond), which is a CPAC execution condition of the candidate PSCell and is set by the T-MN based on the CHO execution condition of the PCell configured by the S-MN. The CHO execution condition of the PCell configured by the S-MN is included in a handover request message transmitted by the S-MN to the T-MN
handover command message (HandoverCommand) including an MCG+SCG configuration information, which corresponds to the PSCell, where information of the candidate PSCell is included in the handover command information identification.
handover command release list (HandoverCommandToReleaseList) including handover command information identification (HandoverCommandInfoId).

Step 506: the source base station/source master base station transmits a reconfiguration message to the terminal UE, and transmits the CHO+CPAC handover configuration information to the UE. The message includes at least one of the following information:
first conditional reconfiguration identification (condReconfigId) corresponding to the candidate PCell identity
first conditional reconfiguration execution condition (condExecutionCond), which is a CHO execution condition of the candidate PCell
conditional reconfiguration list, which includes:
second conditional reconfiguration identification (condReconfigId) corresponding to the candidate PSCell identity. If the T-MN includes a reconfiguration identification in the handover request acknowledge message in step 505, the second conditional reconfiguration identification will adopt the reconfiguration identification.
second conditional reconfiguration execution condition (condExecutionCond), which is a CPAC execution condition of the candidate PSCell. If the T-MN includes a conditional reconfiguration execution condition in the handover request acknowledge message in step 505, the second conditional reconfiguration execution condition adopts the conditional reconfiguration execution condition.
conditional reconfiguration (condRRCReconfig) information, which is a handover command (handovercommand) message corresponding to HandoverCommandinfold in the handover command list message (HandoverCommandList message) transmitted by the T-MN to the S-MN, which corresponds to an MCG and SCG configuration information.

The reconfiguration message may be an RRCReconfiguration message, an RRC-ConnectionReconfiguration message, or other messages.

### III. Optimization Method of CHO+CPAC Handover Performing

In the dual connectivity, the MCG configuration corresponding to the PCell and the SCG configuration corresponding to the PSCell are determined through negotiation between the MN and the SN, thus realizing the joint transmission of UE service data by the MN and the SN and improving the service throughput. Therefore, there is a correspondence (or association) between the PCell and the PSCell, and there is a correspondence (or association) between the MCG configuration and the SCG configuration. If the MCG or SCG configuration changes, the corresponding SCG or MCG configuration will also change.

Due to the preparation stage of CHO+CPAC handover, the T-SN selects the candidate PSCell for the UE, and the T-MN and the T-SN provide the MCG configuration and the SCG configuration (MCG+SCG configuration) for the UE respectively, while for the same candidate PCell, there may be multiple candidate PSCells corresponding to it. Since a cell load condition of each candidate PSCell is different, the SCG configuration corresponding to each candidate PSCcell will be different, the MCG configuration corresponding to the SCG configuration will be different, the MCG configuration of the same candidate PCell will be different because of different candidate PSCells. Therefore, when the same candidate PCell corresponds to multiple different candidate PSCells, the PCell will correspond to multiple MCG configurations. For example, the candidate PCell corresponds to two candidate PSCells (PSCell1 and PSCell2), which belong to T-SN1 and T-SN2, respectively. The T-SN1 and T-SN2 configure SCG1 and SCG2 respectively, and a configuration of the SCG1 is different from that of the SCG2. Therefore, for the candidate PCell, the T-MN will configure MCG1 and MCG2 respectively, corresponding to the SCG1 and SCG2, so as to satisfy the transmission requirements of UE services. Therefore, for the same candidate PCell, the UE will get multiple MCG configurations, which correspond to different SCG configurations.

In CHO+CPAC, UE can monitor candidate cells and perform handover in two methods:
(1) Method 1: the UE first monitors whether the PCell fulfils the CHO execution condition, and then monitors whether the PSCell fulfils the CPAC execution condition after the UE executes CHO.
(2) Method 2: the UE monitors whether the PCell fulfils the CHO execution condition and whether the PSCell fulfils the CPAC execution condition at the same time. If both the PCell and the PSCell fulfil the CHO execution condition and the CPAC execution condition respectively, the CHO and CPAC processes will be performed simultaneously. In this way, the following cases may occur:
when a CHO execution condition of the candidate PCell is fulfilled, but a CPAC execution condition of the candidate PSCell is not fulfilled;
when the CHO execution condition of the candidate PCell is fulfilled and the CPAC execution condition of the candidate PSCell is fulfilled, but the PCell and the PCell are not associated.

Therefore, when the above cases occur, in order to avoid the interruption of the connection between the connected UE and the network, the UE should first perform the CHO process to access the target base station, and then the target base station selects a suitable PSCell for the UE to complete the dual connectivity to improve the service throughput.

Since the T-MN may provide multiple MCG configurations corresponding to different SCG configurations for the UE, when the method 1 is used to monitor the candidate cells and perform handover, the UE first performs the CHO process to access the PCell of the target base station T-MN, and the T-MN needs to determine the MCG configuration selected by the UE, so that the same MCG configuration can be used to transmit data with the UE. Therefore, the disclosure proposes an optimization method of CHO+CPAC handover performing. In a CHO+CPAC mechanism, when the UE first performs the CHO process to access the target base station, the network can determine and use the MCG configuration selected by the UE, thus ensuring the normal data transmission between the UE and the target base station. The disclosure proposes three optimization methods of CHO+CPAC handover performing. In which:

Optimization method 1 of CHO+CPAC handover process: the UE independently selects the MCG configuration and indicates the selected MCG to the T-MN.

In the handover preparation stage, the T-MN sets a configuration identification (configID) for each MCG+SCG configuration. When the UE selects the corresponding MCG configuration, when the UE executes CHO, the reconfiguration complete message transmitted to the T-MN includes the corresponding configuration identification (configID), indicating the MCG configuration selected by the UE to the T-MN. The configuration identification (configID) can be set separately for an identification of the MCG+SCG configuration, or the conditional reconfiguration identification (condReconfigId) set for the candidate PSCell in the MCG+SCG configuration corresponding to the selected MCG configuration can be used as the identification of the MCG+SCG configuration.

When CHO+CPAC handover is performed, if the reconfiguration complete message transmitted by the UE to the T-MN includes the conditional reconfiguration identification (condReconfigId) of the PSCell, it means that the UE executes CHO and CPAC at the same time. Therefore, if the conditional reconfiguration identification (condReconfigId) of the candidate PSCell is used to indicate the identification of the MCG configuration selected by the UE when the UE only performs the CHO process, it is necessary to add secondary information to indicate that CPAC is not executed, which is optional.

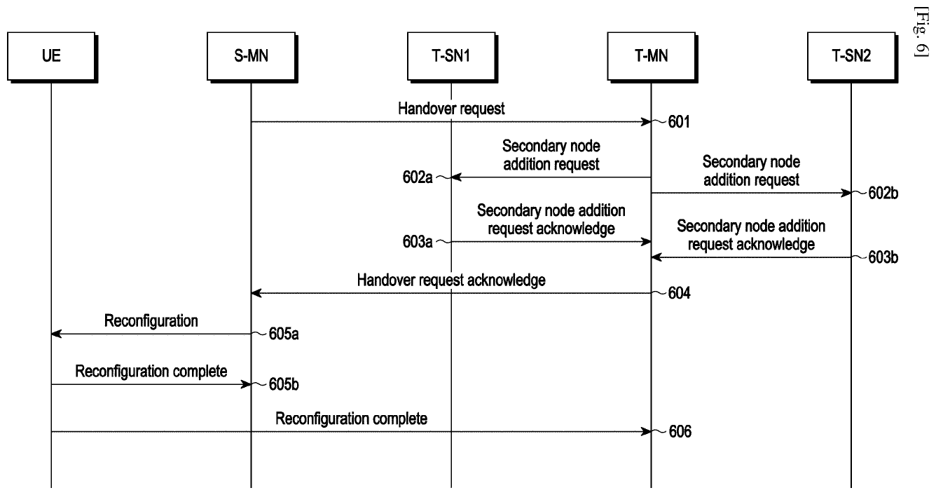

FIG. 6 illustrates a basic flow of optimization method 1 of a CHO+CPAC handover process.

Step 601: the source base station/source master base station transmits a HANDOVER REQUEST message or other messages to the candidate target master base station, indicating that handover is a CHO mechanism, requesting the candidate target base station to take PCell as a candidate cell for UE handover, and performing resource configuration for the UE. The message includes at least one of the following information:
(1) identification information of UE indicating an identification of the UE at the source base station, that is, a source NG-RAN node UE XnAP ID allocated by the source base station.
(2) candidate target cell identity indicating identification information of the candidate target cell for which the source base station requests handover, that is, a Target Cell Global ID, which may be an E-UTRA CGI or NR CGI. Under a mechanism in which CHO and CPAC are combined, it is the candidate primary cell (candidate PCell).

Step 602a or 602b: the candidate target master base station T-MN transmits a secondary node addition request message (S-NODE ADDITION REQUEST message or SGNB ADDITION REQUEST message) or other messages to the candidate target secondary base station T-SN1 or T-SN2, respectively, instructing the candidate target secondary base station T-SN1 or T-SN2 to allocate resources for the CPAC process, and provides the measurement result or candidate PSCell list information to the T-SN for the T-SN to select candidates and determine a final PSCell list.

In step 603a or 603b, the candidate target secondary base station T-SN1 or T-SN2 transmits a secondary node addition request acknowledge message (S-NODE ADDITION REQUEST ACKNOWLEDGE message or SGNB ADDITION REQUEST ACKNOWLEDGE message) or other messages to the candidate target master base station T-MN. The message includes candidate PSCell list information selected by the T-SN1 or T-SN2 for the CPAC process and corresponding SCG radio resource configuration information.

Step 604: the candidate target master base station transmits a HANDOVER REQUEST ACKNOWLEDGE message or other messages to the source base station/source master base station, which is used to transmit CHO and CPAC related information configured by each candidate target master base station for the UE, and candidate PSCell information. The message includes at least one of the following information:
(1) identification information of UE including an identification of the UE on the source base station (Source NG-RAN node UE XnAP ID) and an identification of the UE allocated by the candidate target base station (Target NG-RAN node UE XnAP ID).
(2) requested candidate target cell identity indicating a target cell identity for which handover is requested corresponding to the acknowledge message, which may be an E-UTRA CGI or NR CGI. When CHO+CPAC, the requested candidate target cell is also the candidate PCell. The requested candidate target cell identity is the candidate target cell identity in the corresponding handover request message (step 601).
(3) candidate target base station to source base station container, that is, a Target NG-RAN node To Source NG-RAN node Transparent Container. The container may include the handover command message or the handover command list message (HandoverCommandList message).
a) If the candidate target base station to source base station container includes the handover command message (HandoverCommand message), which includes resource configuration information prepared by the candidate target base station/candidate target secondary base station for UE handover. The information included in the HandoverCommand is the same as the information of the handover command message (HandoverCommand) included in the candidate target base station to source base station container in step 404. Only a configuration identification (configId) is newly added in the conditional reconfiguration addition or modification list (condReconfigToAddModList). The specific contents of the conditional reconfiguration addition or modification list (condReconfigToAddModList) are as follows:
conditional reconfiguration addition or modification list (condReconfigToAddModList) including multiple MCG and SCG configuration information. At least one of the following information is included:
conditional reconfiguration identification (condReconfigId) corresponding to the candidate PSCell identity;
conditional reconfiguration execution condition (condExcutionCond), which is a CPAC execution condition of the candidate PSCell;
configuration identification (configId) for identifying conditional reconfiguration information (one MCG+SCG configuration). When the UE selects the MCG configuration in the conditional reconfiguration information corresponding to the configId to execute CHO, the configuration identification (configId) is included in the reconfiguration complete message transmitted to the target base station to indicate the MCG configuration selected by the UE.
conditional configuration (condRRCReconfig) information, which is an RRC reconfiguration message (RRCReconfiguration) transmitted to the UE, including an MCG and SCG configuration information to the UE. The MCG and SCG configuration information respectively corresponds to the candidate PCell and the candidate PSCell. The candidate PCell is the requested target cell identity included in the handover request acknowledge message transmitted by the T-MN to the S-MN; and the candidate PSCell is a candidate cell corresponding to the conditional reconfiguration identification.
b) If the container includes the handover command list message (HandoverCommandList message), in which multiple MCG and SCG configuration information are provided in a form of a list, and the information included therein is the same as the information of the handover command list message (HandoverCommandList message) included in the candidate target base station to source base station container in step 404. Only a configuration identification is newly added in the handover command information identification (HandoverCommandInfoId). The specific contents of the handover command information identification (HandoverCommandInfoId) are as follows:
handover command information identification (HandoverCommandInfoId), that is, candidate PSCell information corresponding to the handover command, which includes at least one of the following information:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.
configuration identification (configId) for identifying conditional reconfiguration information (one MCG+SCG configuration). When the UE selects the MCG configuration in the conditional reconfiguration information corresponding to the configId to execute CHO, the configuration identification (configId) is included in the reconfiguration complete message transmitted to the target base station to indicate the MCG configuration selected by the UE.

(4) candidate PSCell list information, which is candidate PSCell list information provided by the T-MN, including at least one of the following information:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.

Step 605a: the source base station/source master base station transmits a reconfiguration message to the terminal UE, and transmits the CHO+CPAC handover configuration information to the UE.

(1) In step 604, if the candidate target base station to source base station container includes the handover command message (HandoverCommand message), the reconfiguration message includes at least one of the following information:
first conditional reconfiguration identification (condReconfigId) corresponding to the candidate PCell identity
first conditional reconfiguration execution condition (condExecutionCond), which is a CHO execution condition of the candidate PCell configured by the S-MN
conditional reconfiguration list, which includes:
second conditional reconfiguration identification (condReconfigId) corresponding to the candidate PSCell identity
second conditional reconfiguration execution condition (condExecutionCond), which is a CPAC execution condition of the candidate PSCell configured by the S-MN
conditional reconfiguration (condRRCReconfig) information, which is a handover command message (HandoverCommand) transmitted by the T-MN to the S-MN, including multiple MCG and SCG configuration information allocated by the T-MN to the UE, and a configuration identification (configId) corresponding to each MCG and SCG configuration. When the UE selects the MCG configuration in the conditional reconfiguration information corresponding to the configId to execute CHO, the configuration identification (configId) is included in the reconfiguration complete message transmitted to the target base station to indicate the MCG configuration selected by the UE.

(2) If in step 604, the candidate target base station to source base station container includes the handover command list message (HandoverCommandList message), the reconfiguration message includes at least one of the following information:
first conditional reconfiguration identification (condReconfigId) corresponding to the candidate PCell identity
first conditional reconfiguration execution condition (condExecutionCond), which is a CHO execution condition of the candidate PCell configured by the S-MN
conditional reconfiguration list, which includes at least one of the following information:
second conditional reconfiguration identification (condReconfigId) corresponding to the candidate PSCell identity;
second conditional reconfiguration execution condition (condExecutionCond), which is a CPAC execution condition of the candidate PSCell configured by the S-MN;
configuration identification (configId) for identifying conditional reconfiguration information (one MCG+SCG configuration). When the UE selects the MCG configuration in the conditional reconfiguration information corresponding to the configId to execute CHO, the configuration identification (configId) is included in the reconfiguration complete message transmitted to the target base station to indicate the MCG configuration selected by the UE;
conditional reconfiguration (condRRCReconfig) information, which is a handover command (handovercommand) message corresponding to HandoverCommandinfoId in the handover command list message (HandoverCommandList message) transmitted by the T-MN to the S-MN, which corresponds to an MCG and SCG configuration information.

The reconfiguration message may be an RRCReconfiguration message, an RRC-ConnectionReconfiguration message, or other messages.

Step 605b: the UE transmits a reconfiguration complete message to the source base station/source master base station, indicating that the UE has saved configuration information of CHO+CPAC. The reconfiguration complete message may be an RRCReconfigurationComplete message, an RRCConnectionReconfigurationComplete message, or other messages.

Step 606: the UE transmits a reconfiguration complete message to the target base station, instructing the UE to select a cell of the base station as a target PCell cell.
(1) If the UE first performs the CHO process in the CHO+CPAC handover, the UE can indicate the MCG configuration selected by the UE to the T-MN in one of the following two methods.
a) The reconfiguration complete message will include the configuration identification (configId) corresponding to the MCG selected by the UE, and the configuration identification (configId) is provided to the UE in the reconfiguration message in step 605a. Or,
b) The reconfiguration complete message will include the conditional reconfiguration identification (condReconfigId) and CPAC incomplete indication. The conditional reconfiguration identification is a conditional reconfiguration identification (condReconfigId) set for the candidate PSCell in the MCG+SCG configuration corresponding to the MCG configuration selected by the UE.
(2) If the UE performs the CHO and CPAC processes at the same time, the message will include the conditional reconfiguration identification (condConfigId) corresponding to the target PSCell, and the conditional reconfiguration identification (condConfigId) is provided to the UE in the reconfiguration message in step 605a.

The reconfiguration complete message may be an RRCReconfigurationComplete message, an RRCConnectionReconfigurationComplete message, or other messages.

Optimization method 2 of CHO+CPAC handover process: the UE provides secondary information to the target base station, and the target base station selects an MCG configuration and indicates it to the UE.

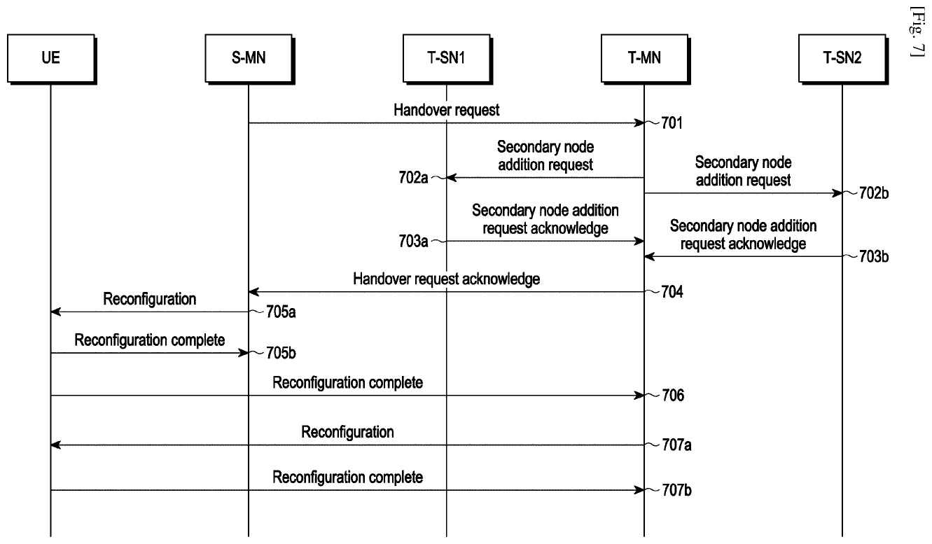

When the UE selects the target base station, the reconfiguration complete message transmitted to the target base station includes the suggested candidate PSCell list information or measurement results. The target base station selects the MCG configuration for the UE according to the information provided by the UE, and indicates the selected MCG configuration to the UE through the reconfiguration message. FIG. 7 illustrates a basic flow of optimization method 1 of a CHO+CPAC handover process.

Steps 701-704 are the same as steps 601-604, and will not be repeated here.

Step 705a: the source base station/source master base station transmits a reconfiguration message to the terminal UE, and transmits the CHO+CPAC handover configuration information to the UE. At least one of the following information is included: identification of candidate PCell, identification of candidate PSCell, CHO execution condition of candidate PCell, CPAC execution condition of candidate PSCell, MCG and SCG configuration information that corresponds to candidate PCell and corresponding candidate PSCell, and configuration identification (configId) corresponding to MCG and SCG configuration.

Step 705b: the UE transmits a reconfiguration complete message to the source base station/source master base station, indicating that the UE has saved configuration information of CHO+CPAC. The reconfiguration complete message may be an RRCReconfigurationComplete message, an RRCConnectionReconfigurationComplete message, or other messages.

Step 706: the UE transmits a reconfiguration complete message to the target base station, instructing the UE to select a cell of the base station as a target PCell cell. In the CHO+CPAC handover, if the UE first performs the CHO process, the reconfiguration complete message will include the candidate PSCell list information or measurement results suggested by the UE. The T-MN determines the MCG configuration used by the UE according to the received information, and transmits a configuration identification corresponding to the MCG to the UE. The configuration identification is transmitted to the UE in step 705a.

The reconfiguration complete message may be an RRCReconfigurationComplete message, an RRCConnectionReconfigurationComplete message, or other messages.

Step 707a: the target base station transmits a reconfiguration message to the UE, indicating the MCG configuration used by the UE. The reconfiguration message includes a configuration identification (configId) corresponding to the MCG configuration selected by the T-MN, and the configuration identification (configId) is provided to the UE in the reconfiguration message in step 705a. When the UE obtains the configuration identification, it uses the MCG configuration corresponding to the configuration identification for data transmission with the T-MN.

Step 707b: the UE transmits a reconfiguration complete message to the target base station. The UE determines configuration information of the MCG according to the configuration identification (configId) received in step 707a, and performs data transmission with the target base station after the MCG configuration is completed.

Optimization method 3 of CHO+CPAC handover process: the target base station configures the UE with a temporary MCG configuration to access the target base station.

The candidate T-MN provides a Temporary MCG configuration for the UE. In the CHO+CPAC handover, if the UE first performs the CHO process, the UE can access the target base station using the temporary MCG configuration. The candidate target base station includes a special C-RNTI in the temporary MCG configuration. When the UE selects the T-MN as the target base station and uses the temporary MCG configuration, in a random access procedure with the T-MN, the UE transmits a C-RNTI Media Access Control (MAC) Control Element (CE) to the T-MN, and a C-RNTI in the C-RNTI MAC CE is the C-RNTI included in the temporary MCG configuration, thereby indicating to the T-MN that the UE uses the temporary MCG configuration.

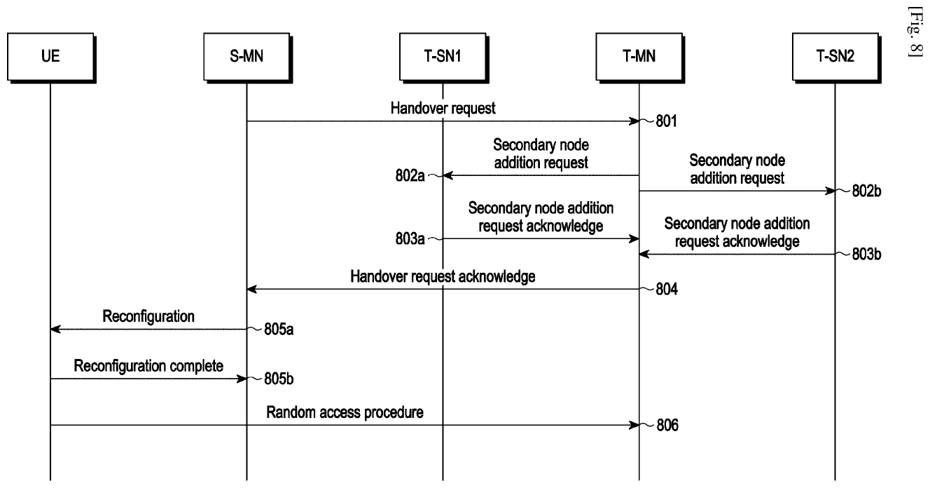

FIG. 8 illustrates a basic flow of optimization method 3 of a CHO+CPAC handover process.

Steps 801-803a/b are the same as steps 601-603a/b, and will not be repeated here.

Step 804: the candidate target master base station transmits a HANDOVER REQUEST ACKNOWLEDGE message or other messages to the source base station/source master base station, which is used to transmit CHO and CPAC related information configured by each candidate target master base station for the UE, and candidate PSCell information. The message includes at least one of the following information:
(1) identification information of UE including an identification of the UE on the source base station (Source NG-RAN node UE XnAP ID) and an identification of the UE allocated by the candidate target base station (Target NG-RAN node UE XnAP ID).
(2) requested candidate target cell identity indicating a target cell identity for which handover is requested corresponding to the acknowledge message, which may be an E-UTRA CGI or NR CGI. When CHO+CPAC, the requested candidate target cell is also the candidate PCell. The requested candidate target cell identity is the candidate target cell identity in the corresponding handover request message (step 801).
(3) candidate target base station to source base station container, that is, a Target NG-RAN node To Source NG-RAN node Transparent Container. The container may include the handover command message or the handover command list message (HandoverCommandList message).
a) If the candidate target base station to source base station container includes the handover command message (HandoverCommand message), which includes resource configuration information prepared by the candidate target base station/candidate target secondary base station for UE handover. The information included in the HandoverCommand is the same as that in the handover command message (HandoverCommand) included in the candidate target base station to source base station container in step 404. Only Temporary MCG configuration information is newly added in the HandoverCommand message. The Temporary MCG configuration information includes a cell radio network temporary identifier (C-RNTI) allocated to the UE terminal, and can be used for the T-MN to identify that the MCG configuration used by the UE is the Temporary MCG configuration.
b) If the container includes the handover command list message (HandoverCommandList message), in which multiple MCG and SCG configuration information are provided in a form of a list. The information included therein is the same as the information of the handover command list message (HandoverCommandList message) included in the candidate target base station to source base station container in step 404. Only Temporary MCG configuration information is newly added in the HandoverCommandList message. The Temporary MCG configuration information includes a cell radio network temporary identifier (C-RNTI) allocated to the UE terminal, and can be used for the T-MN to identify that the MCG configuration used by the UE is the Temporary MCG configuration.
(4) candidate PSCell list information, which is candidate PSCell list information provided by the T-MN, including at least one of the following information:
SSB frequency information (ssbFrequency) indicating frequency information of an SSB (Synchronization Signal Block) of the candidate PSCell, which may be ARFCN-Value.
Global Cell Identifier (CGI) indicating a cell global identifier of the candidate PSCell, including a PLMN Identity and Cell Identity.
physical cell identity (PCI) indicating a physical cell identity of the candidate PSCell, which may be physCellId;
conditional reconfiguration identification (condReconfigId), which is a conditional reconfiguration identification allocated by the T-MN for the candidate PSCell.

Step 805a: the source base station/source master base station transmits a reconfiguration message to the terminal UE, and transmits the CHO+CPAC handover configuration information to the UE. Temporary MCG configuration information is also included. The Temporary MCG configuration information includes a cell radio network temporary identifier (C-RNTI) allocated to the UE, and can be used for the T-MN to identify that the MCG configuration used by the UE is the Temporary MCG configuration.

Step 805b: the UE transmits a reconfiguration complete message to the source base station/source master base station, indicating that the UE has saved configuration information of CHO+CPAC. The reconfiguration complete message may be an RRCReconfigurationComplete message, an RRCConnectionReconfigurationComplete message, or other messages.

Step 806: the UE performs a random access procedure with the target base station, and performs handover from the source base station to the target base station. In the CHO+CPAC handover, if the UE first performs the CHO process and chooses to use the Temporary MCG configuration, then in the random access procedure, the UE transmits a C-RNTI MAC Control Element (MAC CE) to the target base station, where a value of the C-RNTI is the C-RNTI included in the temporary MCG configuration information in the reconfiguration message in step 805a. The message in which the UE transmits the C-RNTI MAC CE to the T-MN may be Message 3 (Msg3) or Message A (MSGA).

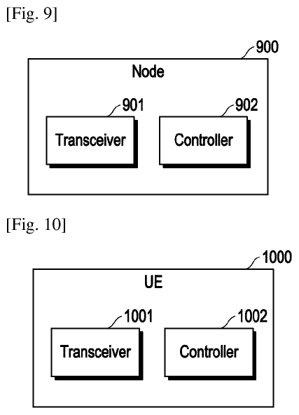

FIG. 9 illustrates a block diagram of a configuration of a node 900 according to various embodiments of the disclosure. The node 900 may include any node herein.

Referring to FIG. 9, a node 900 according to various embodiments of the disclosure may include a transceiver 901 and a controller 902. For example, the transceiver 901 may be configured to transmit and receive signals. For example, the controller 902 may be coupled to the transceiver 901 and configured to perform the aforementioned methods.

FIG. 10 illustrates a block diagram of a configuration of a UE 1000 according to various embodiments of the disclosure.

Referring to FIG. 10, a UE 1000 according to various embodiments of the disclosure may include a transceiver 1001 and a controller 1002. For example, the transceiver 801 may be configured to transmit and receive signals. For example, the controller 1002 may be coupled to the transceiver 1001 and configured to perform the aforementioned methods.

While the UE and nodes are illustrated as having separate functional blocks for convenience of explanation, the configurations of the UE and nodes are not limited thereto. For example, the UE and nodes may include communication units consisting of transceivers and controllers. The UE and nodes may communicate with at least one network node by means of the communication units.

According to embodiments of the disclosure, at least part of the UE and nodes (e.g., modules or functions thereof) or the methods (e.g., operations) may be implemented by instructions which are stored in a computer-readable storage medium (e.g., the memory) in a form of a program module. When executed by a processor or controller, the instructions may enable the processor or controller to perform corresponding functions. The computer-readable medium may include, for example, a hard disk, a floppy disk, a magnetic media, an optical recording media, a DVD, a magneto-optical media, and the like. The instructions may include codes made by a compiler or codes which can be executed by an interpreter. The UE and nodes according to various embodiments of the disclosure may include at least one or more of the aforementioned components, omit some of the aforementioned components, or further include other additional components. Operations executed by the modules, program modules, or other components according to various embodiments of the disclosure may be executed sequentially, parallelly, repeatedly, or heuristically. Alternatively, at least some operations may be executed in different orders or may be omitted, or other operations may be added.

What has been described above are only example embodiments of the disclosure, and are not intended to limit the scope of protection of the disclosure, which is determined by the appended claims.

1-15. (canceled)

16. A method performed by a first node in a wireless communication system, the method comprising:
transmitting, to a second node, a handover request message; and
receiving, from the second node, a handover request acknowledge message,
wherein the handover request acknowledge message includes at least one of conditional handover (CHO) and conditional primary secondary cell group cell (PSCell) addition or change (CPAC) information or a requested candidate target cell identity.

17. The method of claim 16, wherein the CHO and CPAC information includes candidate PSCell information, and
wherein the candidate PSCell information includes at least one of:
a candidate PSCell identity item,
synchronization signal block (SSB) frequency information,
a cell global identifier (CGI) indicating an identifier of the candidate PSCell,
a physical cell identity (PCI),
a conditional reconfiguration identification, or
a target next generation-radio access network (NG-RAN) node to source NG-RAN node container including a handover command message.

18. The method of claim 17, wherein the handover command message includes at least one of:
a conditional reconfiguration remove list,
a conditional reconfiguration addition or modification list including at least one of a conditional reconfiguration identification, a conditional reconfiguration execution condition, a configuration identification, or conditional reconfiguration information, or
temporary master cell group (MCG) configuration information.

19. The method of claim 16, further comprising transmitting, to a user equipment (UE), a radio resource control (RRC) reconfiguration message,
wherein the RRC reconfiguration message includes at least one of:
an execution condition for a candidate primary cell (PCell),
an execution condition for a candidate PSCell, or
conditional RRC reconfiguration information.

20. The method of claim 19, wherein the conditional RRC reconfiguration information includes a master cell group (MCG) configuration and a secondary cell group (SCG) configuration.

21. The method of claim 19, wherein the execution condition for the candidate PCell and the execution condition for the candidate PSCell are set by the first node.

22. The method of claim 19, wherein the candidate PSCell is associated with measurement results of the second node.

23. A method performed by a second node in a wireless communication system, the method comprising:
receiving, from a first node, a handover request message, and
transmitting, to the first node, a handover request acknowledge message,
wherein the handover request acknowledge message includes at least one of conditional handover (CHO) and conditional primary secondary cell group cell (PSCell) addition or change (CPAC) information or a requested candidate target cell identity.

24. The method of claim 23, wherein the CHO and CPAC information includes candidate PSCell information, and
wherein the candidate PSCell information includes at least one of:
a candidate PSCell identity item,
synchronization signal block (SSB) frequency information,
a cell global identifier (CGI) indicating an identifier of the candidate PSCell,
a physical cell identity (PCI),
a conditional reconfiguration identification, or
a target next generation-radio access network (NG-RAN) node to a source NG-RAN node container including a handover command message.

25. The method of claim 24, wherein the handover command message includes at least one of:
a conditional reconfiguration remove list,
a conditional reconfiguration addition or modification list including at least one of a conditional reconfiguration identification, a conditional reconfiguration execution condition, a configuration identification, or conditional reconfiguration information, or
temporary master cell group (MCG) configuration information.

26. A first node in a wireless communication system, the first node comprising:
a transceiver; and
a processor coupled to the transceiver and configured to:
transmit, to a second node entity, a handover request message, and
receive, from the second node entity, a handover request acknowledge message,
wherein the handover request acknowledge message includes at least one of conditional handover (CHO) and conditional primary secondary cell group cell (PSCell) addition or change (CPAC) information or a requested candidate target cell identity

27. The first node of claim 26, wherein the CHO and CPAC information includes candidate PSCell information, and
wherein the candidate PSCell information includes at least one of:
a candidate PSCell identity item,
synchronization signal block (SSB) frequency information,
a cell global identifier (CGI) indicating an identifier of the candidate PSCell,
a physical cell identity (PCI),
a conditional reconfiguration identification, or
a target next generation-radio access network (NG-RAN) node to source NG-RAN node container including a handover command message.

28. The first node of claim 27, wherein the handover command message includes at least one of:
a conditional reconfiguration remove list,
a conditional reconfiguration addition or modification list including at least one of a conditional reconfiguration identification, a conditional reconfiguration execution condition, a configuration identification, or conditional reconfiguration information, or
temporary master cell group (MCG) configuration information.

29. The first node of claim 26, wherein the processer is further configured to transmit, to a user equipment (UE), a radio resource control (RRC) reconfiguration message, and
wherein the RRC reconfiguration message includes at least one of:
an execution condition for a candidate primary cell (PCell),
an execution condition for a candidate PSCell, or
conditional RRC reconfiguration information.

30. The first node of claim 29, wherein the conditional RRC reconfiguration information includes a master cell group (MCG) configuration and a secondary cell group (SCG) configuration.

31. The first node of claim 29, wherein the execution condition for the candidate PCell and the execution condition for the candidate PSCell are set by the first node.

32. The first node of claim 29, wherein the candidate PSCell is associated with measurement results of the second node.

33. A second node in a wireless communication system, the second node comprising;
a transceiver; and
a processor coupled to the transceiver and configured to:
receive, from a first node entity, a handover request message, and
transmit, to the first node entity, a handover request acknowledge message,
wherein the handover request acknowledge message includes at least one of conditional handover (CHO) and conditional primary secondary cell group cell (PSCell) addition or change (CPAC) information or a requested candidate target cell identity.

34. The second node of claim 33, wherein the CHO and CPAC information includes candidate PSCell information, and
wherein the candidate PSCell information includes at least one of:
a candidate PSCell identity item,
synchronization signal block (SSB) frequency information,
a cell global identifier (CGI) indicating an identifier of the candidate PSCell,
a physical cell identity (PCI),
a conditional reconfiguration identification, or
a target next generation-radio access network (NG-RAN) node to source NG-RAN node container including a handover command message.

35. The second node of claim 34, wherein the handover command message includes at least one of:
a conditional reconfiguration remove list,
a conditional reconfiguration addition or modification list including at least one of a conditional reconfiguration identification, a conditional reconfiguration execution condition, a configuration identification, or conditional reconfiguration information, or
temporary master cell group (MCG) configuration information.
